(19) United States
(12) Patent Application Publication
(10) Pub. No.: US 2011/0078065 A1
(43) Pub. Date: Mar. 31, 2011

(54) SYSTEM FOR VOLUME-WEIGHTED AVERAGE PRICE TRADING

(75) Inventors: Gerrit Van Wingerden, Tokyo (JP); Paul-Daniel Lazar, Oradea (RO); James Keith Ducker, Burlingame, CA (US)

(73) Assignee: Tora Holdings, Inc., San Francisco, CA (US)

(21) Appl. No.: 12/872,807

(22) Filed: Aug. 31, 2010

Related U.S. Application Data
(60) Provisional application No. 61/240,030, filed on Sep. 4, 2009.

(51) Int. Cl. G06Q 40/00

(52) U.S. Cl. 705/37

(57) ABSTRACT

Systems, methods, and mediums storing programs for trading financial assets. The method can include receiving a first order specifying a first quantity of financial assets to be traded according to a volume-weighted average price for a trading session and executing the first order during the trading session through algorithmic or traditional trading of the first quantity of financial assets on an exchange. The method can also include creating a second order specifying the first quantity of financial assets to be traded according to a volume-weighted average price measured from a moment of cross to an end of the trading session and exposing the second order to a non-exchange crossing pool concurrently with the execution of the first order. The crossing pool can include multiple orders. The method can include continuously determining whether any of the plurality of orders in the crossing pool can be crossed with the second order.

### CROSS-REFERENCE TO RELATED APPLICATIONS

This application claims the benefit of U.S. Provisional Patent Application No. 61/240,030, filed on Sep. 4, 2009, the contents of which are hereby incorporated by reference.

### FIELD OF THE DISCLOSURE

This generally relates to systems and techniques for implementing volume-weighted average price trading of financial assets. More particularly, this relates to systems and techniques for achieving an improved volume-weighted average price (VWAP) by combining algorithmic and/or traditional trading, such as best efforts VWAP, with a continuous VWAP crossing pool.

### BACKGROUND

Volume Weighted Average Price (VWAP) is a ratio of the value traded to total volume traded over a particular trading horizon (usually one day). It is a measure of the average price a stock traded at over the trading horizon. VWAP is often used as a trading benchmark by investors who aim to be as passive as possible in their execution. Many pension funds and some mutual funds fall into this category. The aim of using a VWAP trading target is to ensure that the trader executing the order does so in line with volume on the market.

Two primary approaches taken by institutional investors seeking to execute orders at VWAP targets are the best efforts VWAP technique and the VWAP crossing pool.

Best efforts VWAP is a technique in which a sales trader or a computer system attempts to achieve VWAP by trading the order in the market. A common execution strategy is to build a volume profile for the underlying financial asset based on historical trading volumes and execute the order in line with that profile at prevailing market levels. For example, a volume profile might indicate that 10% of the daily volume of stock X trades between 9:30 and 9:40, another 5% between 9:40 and 9:45, etc. If the order is for 100 shares of stock X, the trader or computer system executing the best efforts order over the course of the day would attempt to purchase 10 shares between 9:30 and 9:40 at the prevailing market price during that interval, another 5 shares between 9:40 and 9:45, and so on.

VWAP cross is a technique involving posting the order to a crossing pool/matching engine. If another investor places an order on the opposite side of the same stock in the pool, it will be matched at VWAP for the trading session. Of course, the actual VWAP price will not be known until the end of the day or trading session. But because both parties have agreed to a binding transaction to trade at VWAP, they will have the actual VWAP price applied retroactively to their transaction.

Prior systems have attempted to combine best efforts VWAP with the VWAP cross. In one system, a pre-open VWAP crossing pool is provided. Customers may submit orders for the VWAP price on either side of a stock and offsetting orders are matched (e.g., Sell 5000 of X stock at VWAP, Buy 5000 of X stock at VWAP). When the pre-open crossing pool is closed (typically right before the market opens), unmatched orders are passed to a best efforts mechanism for best efforts VWAP execution over the trading day. Thus, customers have a limited opportunity to obtain a guaranteed actual VWAP before the market opens, and then they are provided a best efforts VWAP execution thereafter.

In another system, a pre-open crossing pool, a best efforts mechanism, and an intra-day crossing pool are provided. The pre-open crossing pool operates as previously described. Unmatched orders are then passed to the best efforts mechanism for execution throughout the trading session. The intra-day crossing pool allows customers to submit orders for guaranteed VWAP later in the day. The intra-day crossing pool provides multiple balance-of-day or point in time VWAP trading horizons. For example, the first horizon may be from 9:45 to close, the second horizon from 10:00 to close, and so on. In order to participate in a particular crossing session to trade at a particular VWAP horizon, the customer must submit its order prior to the beginning of the session. If an order submitted to an intra-day crossing session is not matched, it is passed to the best efforts mechanism for execution throughout the trading day.

With either system described above, however, once the VWAP cross fails to yield a cross and the order is passed to the best efforts mechanism, the order cannot participate again in the VWAP cross.

### SUMMARY

This relates to a system for trading financial assets, such as listed securities, listed Futures and Options, and any OTC marketplace such as Swaps, CFDs, and P-Notes, where a VWAP price is created over the trading session of the asset. The system can facilitate the trading of a target quantity of a financial asset so as to approximate or achieve a Volume-Weighted Average Price (VWAP) of the financial asset over a trading session. VWAP is a ratio of the value traded to total volume traded of a financial asset over a particular time horizon, such as a day-long trading session. The system advantageously combines VWAP target execution techniques, which generally approximate VWAP, with guaranteed VWAP execution techniques, which wholly achieve VWAP.

The system can employ algorithmic trading as a VWAP target execution technique. The algorithmic trading can be a so-called ‘best efforts’ technique in which portions of a target quantity of a financial asset are traded on an electronic exchange throughout the trading session. The portions can be determined based on a volume profile of the financial asset. The volume profile can be based on a previously measured average volume traded for the financial asset over a particular time period.

VWAP algorithmic trading can be beneficial because the target quantity of the financial asset is virtually guaranteed to be traded over the course of the trading session. Furthermore, the average execution price will approximate the VWAP for the trading session. The disadvantages are that the trading of the financial asset on the exchange will most likely influence the financial asset's market price, thus negatively affecting the financial asset's VWAP. In addition, the algorithmic trading is not guaranteed to achieve the financial asset's actual VWAP (and very often does not) because the success of the algorithmic trading depends on the accuracy of assumptions regarding the expected volume to be traded (contained in the volume profile) and on the execution price achieved for each portion of the order.

The system can employ a crossing pool as a guaranteed VWAP execution technique. The crossing pool can be a private crossing network unaffiliated with any exchange. The crossing pool can be designed to facilitate the matching of submitted orders that take contrary positions. When two orders are matched, the crossed portions of the orders achieve an actual VWAP measured from the point of cross to the end of the trading session. Having an order cross in a crossing pool can be beneficial because the order can achieve the true VWAP from the moment of cross to the end of the trading session without influencing the financial asset's market price on an exchange. However, the disadvantage is that there is no guarantee that an order will cross in the crossing pool.

The system can also employ traditional VWAP execution provided by a sales trading desk. Sales trading desks attempt to work orders manually throughout the day using experience and intuition. Sales traders augment manual order execution with manual attempts (e.g., telephone, instant messaging, email) to find counter parties where the sales trader can cross the order, or balance of an order, at VWAP. An advantage to using the traditional VWAP execution, or human execution, is that the insight and experience of the sales trader can help the trader to be more adaptive and predictive than a predetermined algorithm. A disadvantage to using traditional VWAP execution is that the order may be compromised when the sales trader speaks to other trading clients about the order. This is known as “information leakage.” This information shared with a potential counterparty can be used against the original order in the marketplace.

The system can combine the traditional and algorithmic trading with the crossing pool to approximate or achieve VWAP for a financial asset. When an order is received, a second order can be created containing the same particulars (e.g., the position (BUY or SELL); the identity of the financial asset; the quantity to be traded). The system can process the received order through algorithmic trading or traditional methods while concurrently and continuously exposing the second order to the crossing pool. As portions of the order are executed by the algorithmic trading, both orders can be amended down to reflect the lower quantity left to be traded. Similarly, as portions of the order are crossed in the crossing pool, both orders can be amended down to reflect the lower quantity left to be traded. When an order has been fully executed and/or crossed, i.e., when there is no quantity left to be traded, both orders can be canceled and removed.

Accordingly, an investor submitting an order to trade at VWAP can receive the benefits of both techniques while minimizing the disadvantages of each. These benefits can be enjoyed throughout the trading session until the order is completely filled. The investor is thus provided with VWAP execution that is at a minimum no worse than the algorithmic trading result, at best a perfect VWAP result with no market impact, and most likely a VWAP result at least slightly better than the algorithmic trading result.

In addition, the system can expose newly submitted orders to the crossing pool almost immediately. This is because the crossing pool can be a continuous VWAP crossing pool designed to achieve a VWAP measured from the moment of cross to the end of the trading session. Thus, the crossing pool does not restrict entry times for new orders and does not restrict old orders (orders that were previously added to the pool) from maintaining the future, continued option of a VWAP cross. Accordingly, an investor submitting an order during the middle of a trading session need not wait a predetermined time (e.g., for the start of a new VWAP crossing session to begin) for the order to be exposed to the crossing pool, but may have the order exposed to the crossing pool almost immediately (after initial processing) and stay within the pool for the life of the order until the order is completely filled or canceled. Thus, for example, the investor may more quickly and effectively capitalize on newly-released information pertaining to a particular financial asset. Since markets can change 10% or more in a matter of minutes, this is a significant innovation for investors. Additionally, orders already in the crossing pool benefit as well by having the opportunity to potentially cross with any new orders sooner than if entry times were restricted. Furthermore, an order that did not have a match in the crossing pool when first entered has the opportunity to find the balance of the order throughout the day giving the order the maximum amount of opportunity available within the trading day to find a counterparty.

In traditional VWAP cross trading, past mechanisms have forced the investor to absorb incremental risk of anywhere from a few minutes of trading to a whole day's trading, depending on the provider. Continuous VWAP cross allows the investor to strip out incremental risk immediately, thus lowering the overall risk for the investor on the trade. Furthermore, the rate of cross within the cross pool can be improved by the amount of incremental crossing time that the continuous VWAP crossing mechanism provides over traditional point-in-time based VWAP pools.

In an embodiment, a method can include receiving a first order specifying a first quantity of financial assets to be traded according to a volume-weighted average price for a trading session and executing the first order during the trading session through algorithmic or traditional trading of the first quantity of financial assets on an exchange. The method can also include creating a second order specifying the first quantity of financial assets to be traded according to a volume-weighted average price measured from a moment of cross to an end of the trading session and exposing the second order to a non-exchange crossing pool concurrently with the execution of the first order. The crossing pool can include multiple orders. The method can include continuously determining whether any of the plurality of orders in the crossing pool can be crossed with the second order. The method can be implemented using a computer.

In an embodiment, the method can include identifying a contra-order from the plurality of orders in the crossing pool that can be crossed with the second order, the contra-order specifying a second quantity of financial assets to be traded according to a volume-weighted average price measured from a moment of cross to the end of the trading session. The second order can be crossed with the contra-order.

In an embodiment, the method can include removing the second order from the crossing pool and canceling the first order when the first quantity is equal to or less than the second quantity.

In an embodiment, the method can include amending the first and second orders to change the first quantity to be equal to a difference between the first quantity and the second quantity when the first quantity is greater than the second quantity.

In an embodiment, the algorithmic or traditional trading of the first quantity of financial assets on the exchange can include trading portions of the first quantity of financial assets throughout the trading session in accordance with a volume profile of the financial asset.

In an embodiment, the method can include amending, when a portion of the first quantity of financial assets is traded, the first and second orders to change the first quantity to be equal to a difference between the first quantity and the portion.

In an embodiment, new orders can be received and immediately exposed to the crossing pool at any time during the trading session.

In an embodiment, the method can include verifying that a user profile associated with the first order permits cross pool trading as a prerequisite to performing the steps of creating the second order, exposing the second order to the crossing pool, and determining whether any of the plurality of orders in the crossing pool can be crossed with the second order.

In an embodiment, a method can include receiving a first order specifying a first quantity of financial assets to be traded according to a volume-weighted average price for a trading session and causing the first order to be executed during the trading session through algorithmic trading of the first quantity of financial assets on an electronic trading exchange. The method can also include creating a second order specifying the first quantity of financial assets to be traded according to a volume-weighted average price measured from a moment of cross to an end of the trading session causing the second order to be exposed to a non-exchange crossing pool concurrently with the execution of the first order. The crossing pool can include multiple orders. The method can be implemented using a computer.

In an embodiment, a computer-readable medium can store a computer program that causes a computer to execute any of the described methods.

In an embodiment, a system can include an order manager configured to receive a first order specifying a first quantity of financial assets to be traded according to a volume-weighted average price for a trading session. The system can also include an algorithmic engine configured to execute the first order during the trading session through algorithmic trading of the first quantity of financial assets on an electronic trading exchange. The system can additionally include a cross poster configured to instruct the order manager to create a second order specifying the first quantity of financial assets to be traded according to a volume-weighted average price measured from a moment of cross to an end of the trading session. The cross poster can also be configured to expose the second order to a non-exchange crossing pool concurrently with the execution of the first order, the crossing pool being configured to continuously determine whether any of multiple orders in the crossing pool can be crossed with the second order. In other embodiments, various features of the described methods can be implemented in this or another system.

### BRIEF DESCRIPTION OF THE DRAWINGS

FIG. 1 illustrates an example of system for trading financial assets.

FIG. 2 illustrates an example of a graphical user interface.

FIG. 3 illustrates an example of a process for trading financial assets.

FIG. 4 illustrates an example of a process for trading financial assets.

FIG. 5 illustrates an example of a computing device.

### DETAILED DESCRIPTION

In the following description of embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the invention.

This relates to a system for trading financial assets, such as listed securities, listed Futures and Options, and any OTC marketplace such as Swaps, CFDs, and P-Notes, where a VWAP price is created over the trading session of the asset. The system can facilitate the trading of a target quantity of a financial asset so as to approximate or achieve a Volume-Weighted Average Price (VWAP) of the financial asset over a trading session. VWAP is a ratio of the value traded to total volume traded of a financial asset over a particular time horizon, such as a day-long trading session. The system advantageously combines VWAP target execution techniques, which generally approximate VWAP, with guaranteed VWAP execution techniques, which wholly achieve VWAP.

The system can employ algorithmic trading as a VWAP target execution technique. The algorithmic trading can be a so-called ‘best efforts’ technique in which portions of a target quantity of a financial asset are traded on an electronic exchange throughout the trading session. The portions can be determined based on a volume profile of the financial asset. The volume profile can be based on a previously measured average volume traded for the financial asset over a particular time period.

VWAP algorithmic trading can be beneficial because the target quantity of the financial asset is virtually guaranteed to be traded over the course of the trading session. Furthermore, the average execution price will approximate the VWAP for the trading session. The disadvantages are that the trading of the financial asset on the exchange will most likely influence the financial asset's market price, thus negatively affecting the financial asset's VWAP. In addition, the algorithmic trading is not guaranteed to achieve the financial asset's actual VWAP (and very often does not) because the success of the algorithmic trading depends on the accuracy of assumptions regarding the expected volume to be traded (contained in the volume profile) and on the execution price achieved for each portion of the order.

The system can employ a crossing pool as a guaranteed VWAP execution technique. The crossing pool can be a private crossing network unaffiliated with any exchange. The crossing pool can be designed to facilitate the matching of submitted orders that take contrary positions. When two orders are matched, the crossed portions of the orders achieve an actual VWAP measured from the point of cross to the end of the trading session. Having an order cross in a crossing pool can be beneficial because the order can achieve the true VWAP from the moment of cross to the end of the trading session without influencing the financial asset's market price on an exchange. However, the disadvantage is that there is no guarantee that an order will cross in the crossing pool.

The system can also employ traditional VWAP execution provided by a sales trading desk. Sales trading desks attempt to work orders manually throughout the day using experience and intuition. Sales traders augment manual order execution with manual attempts (e.g., telephone, instant messaging, email) to find counter parties where the sales trader can cross the order, or balance of an order, at VWAP. An advantage to using the traditional VWAP execution, or human execution, is that the insight and experience of the sales trader can help the trader to be more adaptive and predictive than a predetermined algorithm. A disadvantage to using traditional VWAP execution is that the order may be compromised when the sales trader speaks to other trading clients about the order. This is known as “information leakage.” This information shared with a potential counterparty can be used against the original order in the marketplace.

The system can combine the traditional and algorithmic trading with the crossing pool to approximate or achieve VWAP for a financial asset. When an order is received, a second order can be created containing the same particulars (e.g., the position (BUY or SELL); the identity of the financial asset; the quantity to be traded). The system can process the received order through algorithmic trading or traditional methods while concurrently and continuously exposing the second order to the crossing pool. As portions of the order are executed by the algorithmic trading, both orders can be amended down to reflect the lower quantity left to be traded. Similarly, as portions of the order are crossed in the crossing pool, both orders can be amended down to reflect the lower quantity left to be traded. When an order has been fully executed and/or crossed, i.e., when there is no quantity left to be traded, both orders can be canceled and removed.

Accordingly, an investor submitting an order to trade at VWAP can receive the benefits of both techniques while minimizing the disadvantages of each. These benefits can be enjoyed throughout the trading session until the order is completely filled. The investor is thus provided with VWAP execution that is at a minimum no worse than the algorithmic trading result, at best a perfect VWAP result with no market impact, and most likely a VWAP result at least slightly better than the algorithmic trading result.

In addition, the system can expose newly submitted orders to the crossing pool almost immediately. This is because the crossing pool can be a continuous VWAP crossing pool designed to achieve a VWAP measured from the moment of cross to the end of the trading session. Thus, the crossing pool does not restrict entry times for new orders and does not restrict old orders (orders that were previously added to the pool) from maintaining the future, continued option of a VWAP cross. Accordingly, an investor submitting an order during the middle of a trading session need not wait a predetermined time (e.g., for the start of a new VWAP crossing session to begin) for the order to be exposed to the crossing pool, but may have the order exposed to the crossing pool almost immediately (after initial processing) and stay within the pool for the life of the order until the order is completely filled or canceled. Thus, for example, the investor may more quickly and effectively capitalize on newly-released information pertaining to a particular financial asset. Since markets can change 10% or more in a matter of minutes, this is a significant innovation for investors. Additionally, orders already in the crossing pool benefit as well by having the opportunity to potentially cross with any new orders sooner than if entry times were restricted. Furthermore, an order that did not have a match in the crossing pool when first entered has the opportunity to find the balance of the order throughout the day giving the order the maximum amount of opportunity available within the trading day to find a counterparty.
In traditional VWAP cross trading, past mechanisms have forced the investor to absorb incremental risk of anywhere from a few minutes of trading to a whole day's trading, depending on the provider. Continuous VWAP cross allows the investor to strip out incremental risk immediately, thus lowering the overall risk for the investor on the trade. Furthermore, the rate of cross within the cross pool can be improved by the amount of incremental crossing time that the continuous VWAP crossing mechanism provides over traditional point-in-time based VWAP pools.

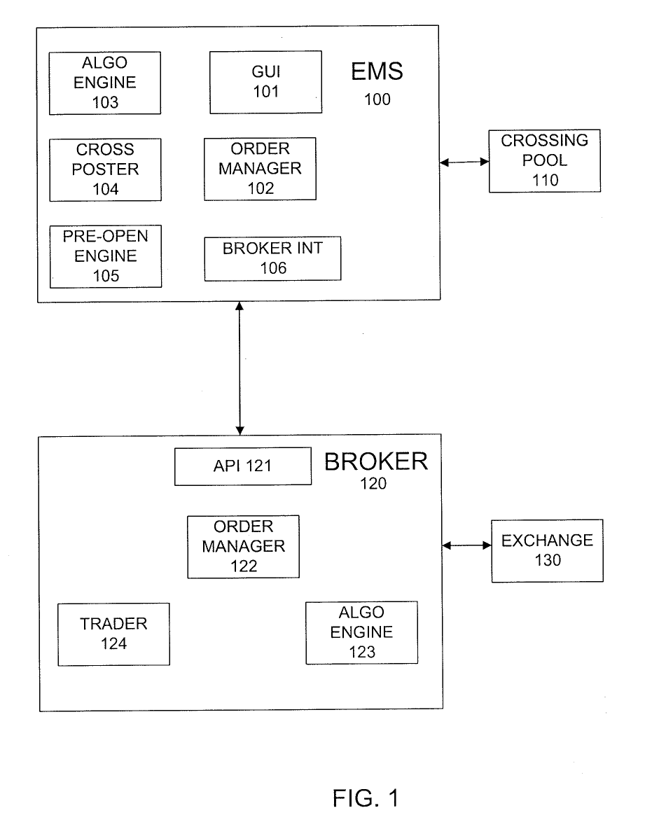

FIG. 1 illustrates an embodiment of an exemplary system for trading financial assets. The system can include an execution management system (EMS) 100, crossing pool 110, broker 120, and exchange 130.

Execution management system (EMS) 100 includes several components for managing the execution of an order. The order can specify a quantity of financial assets to trade according to a volume-weighted average price of the financial asset for a trading session. A financial asset can be any asset that is able to be traded on an electronic exchange (e.g., NASDAQ, NYSE Arca, CME Globex), sometimes referred to as an electronic communication network. The financial asset can be a security, such as a stock or bond, a foreign currency, or an exchange-traded derivative, for example.

The volume-weighted average price (VWAP) is a ratio of the value traded to total volume traded of a specified financial asset over a defined period of time, such as a day-long trading session. VWAP can be calculated using the following equation:

$${P}_{VWAP} = \frac{{\sum }_{j} {P}_{j} \cdot {Q}_{j}}{{\sum }_{j} {Q}_{j}}$$

where P_{VWAP} is the volume-weighted average price, j represents each individual trade that takes place over the defined period of time, Pⱼ is the price of trade j, and is the quantity of trade j.

The period of time over which VWAP is measure for a particular financial asset may vary. A typical period of time over which VWAP is calculated is a day-long trading session. Thus, the volume and price of trades of a financial asset can be measured from 9:30 AM to 4:00 PM. Alternatively, a different period of time can be specified. For example, VWAP can be measured over the course of just a few minutes to several days, a week, or a month. Additionally, as will be discussed in more detail below, the period of time can be specified as the balance of the trading session (i.e., from a moment t till the end of the trading session).

An order can be submitted using graphical user interface (GUI) 101. GUI 101 can be a component of EMS 100, as shown in FIG. 1. Alternatively, GUI 101 can be a separate component located physically away from EMS 100 on a separate computer system, such as a customer's computer system. In such a case, GUI 101 can communicate with EMS 100 via a network, such as by means of the Internet.

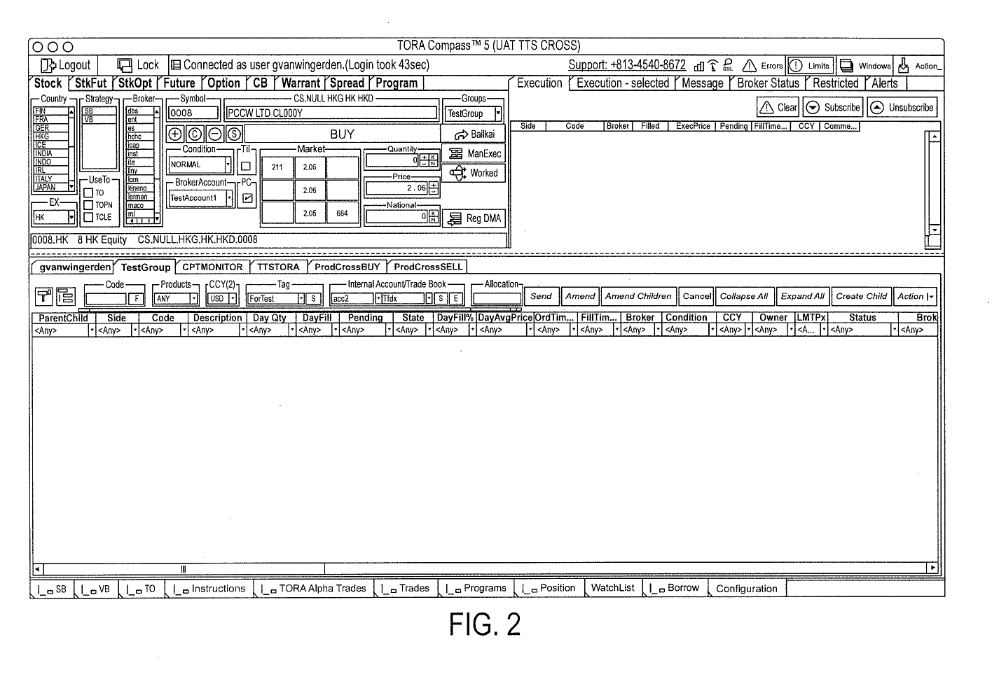

An exemplary screenshot of an embodiment of GUI 101 is depicted in FIG. 2. Specifically, FIG. 2 is a screenshot of a graphical user interface for Tora Compass, an execution management system created by Tora Trading Services Ltd.

Returning to FIG. 1, order manager 102 can manage orders received from GUI 101 and route them to other components of the system as appropriate. When a VWAP order is received, order manager 102 can provide it to an algorithmic engine whose goal is to approximate VWAP as closely as possible.

There can be two algorithmic engines: an engine 103 in EMS 100 and an engine 123 in broker 120. The algorithmic engines can implement a technique known as ‘best efforts’ VWAP. Best efforts VWAP attempts to approximate VWAP by executing portions of an order over the course of a trading session in line with a volume profile of the financial asset being traded. The portions to be traded during particular periods throughout the trading session can be determined based on a volume profile of the financial asset.

The volume profile can be based on a previously measured average volume traded for the financial asset over a past time period. For example, assuming the volume profile is for VWAP over the course of a day-long trading session, the volume profile could take into consideration the average volume traded at particular times throughout the day, as measured for every day the market has been open for the past month. The assumption is that trading of a particular financial asset during a given day will likely occur in a similar manner as it has over the past month. A large number of volume profiles could potentially be created for a given financial asset, each one measuring average volume traded over different past time periods (e.g., over the last two days, the last week, the last month, a five-day period two months ago, etc.).

Different algorithmic engines thus can employ different volume profiles of a given financial asset. Accordingly, the trading algorithm employed by each engine can be different and each engine can achieve different results on a given day. Algorithmic engine 103 in EMS 100 can thus be different from algorithmic engine 123 in broker 120. A customer can choose which engine to use via GUI 101, in which case the order could specify the engine to use. Alternatively, order manager 102 can store a customer profile for the customer that contains preferences, such as which algorithmic engine to use.

After determining which algorithmic engine to use, order manager can submit the order to the appropriate algorithmic engine. If the order manager determines to submit the order to algorithmic engine 123 in broker 120, order manager can send the order via broker interface 106 to application program interface 121, which passes the order to broker's order manager 122. Order manager 122 can then submit the order to algorithmic engine 123. Upon receipt of the order, algorithmic engine 103 or 123 can proceed to automatically execute portions of the order on exchange 130 in line with the algorithmic engine's volume profile for the financial asset being traded.

In an embodiment, the order or customer profile can specify to perform a best efforts VWAP by means of a trader 124 at broker 120. Trader 124 can be a human being. Trader 124 can manually execute a best efforts algorithm by submitting individual orders to exchange 130 in line with a volume profile of the financial asset.

Cross poster 104 can monitor orders received by order manager 102. When an order is received, cross poster can determine whether the order is eligible to be exposed to crossing pool 110. Cross poster can determine this based on whether any special conditions or instructions are attached to the order and/or whether a customer's profile indicates that exposure to a crossing pool is permissible. If determined that the order can be exposed to crossing pool 110, cross poster 104 instructs order manager 102 to create a second order substantially identical to the originally received order. The second order should specify the financial asset to be traded and the quantity to be traded. Order manager 102 can then expose the second order to crossing pool 110.

Crossing pool 110 can be a private crossing network unaffiliated with exchange 130. Crossing pool 110 can be designed to facilitate the crossing/matching of submitted orders that take contrary positions. When two orders are matched, the crossed portions of the orders can achieve an actual VWAP measured from the point of cross to the end of the trading session. Crossing pool 110 can be continuous throughout the trading session. Accordingly, orders exposed to crossing pool 110 are exposed to the pool for the entire trading session until the orders are completely executed or cancelled. In addition, crossing pool 110 can allow for immediate entry of new orders throughout the trading session. It can be continuously determined whether any of the orders in the crossing pool can be crossed. This determination can occur very often, such as multiple times per minute or second, or even to the millisecond, depending on the speed of the computing system.

Pre-open matching engine 105 can be used to attempt to match an order submitted before the trading session has begun with any other orders submitted before the trading session has begun. Pre-open matching engine 105 can essentially mimic a crossing pool with an ending point before the trading session begins. If two orders are matched, the matched portions of the orders achieve an actual VWAP for the trading session.

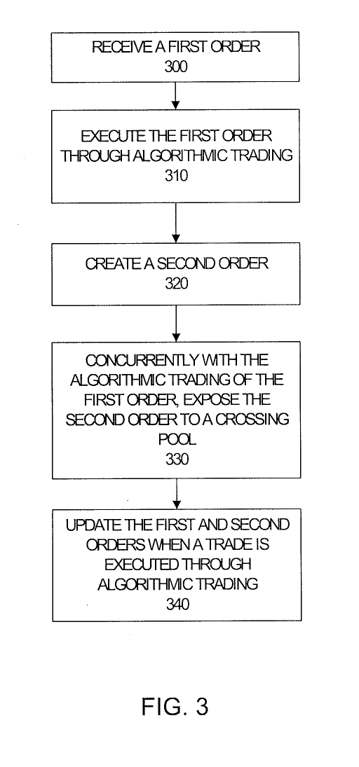

FIG. 3 is an exemplary process that can be executed by the system.

A first order can be received (300). The first order can specify a quantity of financial assets to be traded according to VWAP for a trading session. In this example, assume the order is received at 9:00 AM, before the market has opened, and it specifies to BUY 1000 shares of XYZ Corp (BUY 1000 XYZ). The order specifies VWAP for the entire trading day, from 9:30 AM to 4:00 PM. In an embodiment, this order could be eligible to be submitted to pre-open matching engine 105, which could attempt to match orders submitted prior to 9:29 AM, for example. If the entire order was matched in pre-open matching engine 105, it would be guaranteed the actual VWAP price of XYZ Corp. for the day. If only a portion of the order were matched (e.g., 200 shares), the order could be amended down to specify the quantity left to be traded of XYZ Corp. (e.g., 800 shares).

When the market opens, the first order can be executed (310) through algorithmic trading of the quantity of financial assets on exchange 130. Accordingly, portions of the order would be executed in line with the particular volume profile of XYZ Corp. being used by the algorithmic engine 103 or 123 or trader 124, for example. For example, if the volume profile of XYZ Corp. indicates that 10% of the volume is traded between 9:30 and 9:35, then the algorithmic engine/trader will attempt to buy 100 shares of XYZ Corp. at the market price between 9:30 and 9:35.

A second order can be created (320). The second order can specify the quantity of financial assets to be traded according to VWAP measured from a moment of cross to an end of the trading session (i.e., 4:00 PM). Concurrently with the algorithmic trading of the first order, the second order can be exposed (330) to crossing pool 110.

When a portion of the order is executed through algorithmic trading, the first and second orders can be updated (340) to reflect the execution. Specifically, the first and second orders can be amended down so that their specified quantities are consistent with the number of the financial asset left to be traded. In the example, when 100 shares of XYZ Corp. are bought between 9:30 and 9:35, the first and second orders are each amended to specify BUY 900 XYZ.

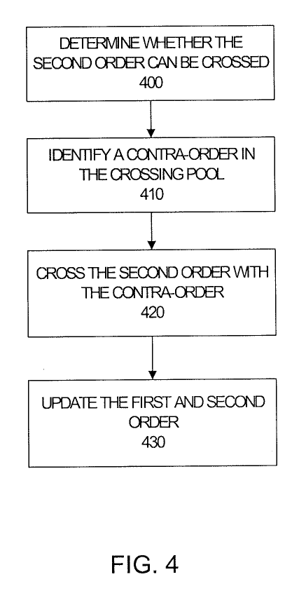

FIG. 4 is a further process that can be executed by the system and can be viewed as a continuation of the process of FIG. 3.

It can be determined (400) whether the second order can be crossed with any other orders exposed to crossing pool 110. A contra-order can be identified (410). The contra-order can specify a second quantity of financial assets to be traded according to VWAP measured from the moment of cross to the end of the trading session. For example, the contra-order could specify SELL 500 shares of XYZ Corp. The second order can then be crossed (420) with the contra-order.

After the second order is crossed with the contra-order, the first and second orders can be updated (430) to reflect the cross. If the quantity specified by the second order is equal to or less than the quantity specified by the contra-order, the second order can be removed from crossing pool 110 and the first order can be canceled. For example, assuming before cross the second order recited BUY 900 XYZ and the contra-order recited SELL 900 XYZ, then the entire quantity to be traded of the second order is crossed with the contra-order. Accordingly, the second order should no longer be exposed to crossing pool 110 and the first order should be canceled before it is executed any further through algorithmic trading.

On the other hand, if the quantity specified by the second order is greater than the quantity specified by the contra-order, the first and second orders can be amended to change the quantity to be traded to be equal to the difference between the second order's quantity and the contra-order's quantity. For example, assuming before cross the second order recited BUY 900 XYZ and the contra-order recited SELL 500 XYZ, then only a portion (i.e., 500) of the quantity of shares to be traded is crossed with the contra-order. Accordingly, the first and second orders should be updated to reflect the new quantity to be traded, which in this case would be 400 shares.

The embodiments described thus far have assumed a tight coupling between the crossing pool and the best-efforts VWAP mechanism where a VWAP cross and the amend/cancel operation can be performed virtually simultaneously.

This may not always be the case. For example, a broker operating the crossing pool and a broker processing the best efforts VWAP order may be different entities. Even in the case that they are the same entity, the VWAP engine and crossing pool could be implemented in distinct pieces of computer code running on different computer systems, possibly in different geographic locations.

When the VWAP cross and the amend/cancel operation are not executed simultaneously, at least two problems can arise: overfills and overlapping executions. Both problems can occur if there is a cross and the best efforts order executes before the amend operation can be completed. If the remaining quantity of the best efforts order after the execution is less than the cross size, then there will be an overfill. That is, for example, the combination of the cross and the just-completed best efforts execution results in too many shares having been bought or sold, so that the ultimate order has been over-executed. On the other hand, if the remaining quantity of the best efforts order after the execution is greater than the cross size, there will be an overlapping execution, which can interfere with the order trajectory of the best efforts mechanism. For example, suppose an order to BUY 10000 shares is placed at 9:30 and at 9:45 the best efforts mechanism executes 1000 shares at a price of 100. However, at 9:44:59, 1000 shares cross at the VWAP price from 9:44:59 till the end of the trading day. The crossed VWAP price now will include the 1000 shares executed in the market at 100 by the best-efforts mechanism. Assume that the market then trades at a much lower level for the rest of the day immediately thereafter. The problem is that the best-efforts mechanism would expect to execute the remaining 8000 shares (assuming no more crosses) at the much lower level from 9:45 to the end of the trading day, but the crossed 1000 shares will be at a VWAP price that includes the larger-than-ideal and higher-priced best efforts trade at 9:45.

These problems can be addressed by the broker who implements the VWAP cross mechanism taking some overfill and pricing risk, as well as by hiding the overfills and overlapping executions from the user. In an embodiment that hides overfills and overlapping executions from the end user, two additional legs, or orders, can be added to the transaction. The four legs are as follows:

Leg A—the best efforts VWAP order;

Leg B—the shadow order in the crossing pool (this is the same side as Leg A);

Leg C—a new cross leg that is created as a sibling order of the Leg A (this is the same side as Leg B); and

Leg D—a new cross leg that is created as the contra trade to the Leg C order (this is the opposite side of Leg C).

Legs B and D are hidden from the end user. When a cross occurs in the pool via the Leg B order, the cross is not immediately shown to the user. Instead, an amend/cancel operation is made to the Leg A order. If the amend operation succeeds, the Leg C trade is created and a contra Leg D trade is created on the broker side (this is hidden from the user). The Leg C trade may not mirror the Leg B trade exactly. For example, it could have a smaller quantity in case there was an overfill. Alternatively, it could have a different price (both a different amended EOD price and intermediate price(s)) in case there was an overlapping execution. In that case, the start time of the VWAP interval can be amended to the acknowledgement time of the amend operation on the Leg A trade.

With these legs in place, the system can detect whether there is an overfill situation by netting off (that is, adding together) the Leg B and Leg D quantities to determine whether there is a non-zero position remaining. The system can then either issue an automatic unwind of the overfill (usually via a best efforts algorithm) or alert a trader to the position so he can manually unwind, or otherwise handle, the position. In the event that there is an overfill equal to the size of the cross, no Leg C order will be created and the entire quantity can be unwound transparently to the user. Unwinding signifies performing contra trading to the overfill such that the overfill is corrected (unwound).

Examples are provided below to illustrate an exemplary process according to this embodiment, in which (1) there is no overfill, and (2) there is an overfill.

This is an example of the process when an overfill does not occur:

1. A Client places a best efforts VWAP order to buy 10000 shares of X. Accordingly, a Leg A trade to buy 10000 shares of X is created.

2. Crossposter creates a shadow order to cross buy 10000 shares at VWAP in the crossing pool. This is the Leg B trade.

3. 100 shares of the best efforts order execute. So Crossposter amends the quantity of Leg B to 9900 shares.

4. Contra liquidity appears in the pool and 5000 shares are crossed at guaranteed VWAP. So Crossposter attempts to amend the Leg A trade to 4900 shares (that is, 10000 (the original order size)−100(the executed best efforts portion)−5000(the crossed portion)=4900 (left to be executed)). Once the amend on Leg A is acknowledged, Crossposter can create Leg C and Leg D. Leg C is a client order to buy 4900 shares at guaranteed VWAP and Leg D is an internal order (hidden from Client) to sell 4900 shares at guaranteed VWAP to the client. Netting off (adding together) the Leg B (bought 5000 shares) and Leg D (sold 5000 shares) yields zero. Accordingly, a zero position remains and it is determined that no overfill occurred.

5. The orders then continue to execute via best efforts and crossing. For example, 100 more shares execute at best efforts VWAP (Leg A) and so Crossposter amends Leg B to 4800 shares. Another 100 shares execute at best efforts VWAP (Leg A), so Crossposter amends Leg B to 4700 shares. This continues until the order completes. If another cross occurs, the procedure in step 4 is repeated to determine whether an overfill occurred.

This is an example of the process when an overfill occurs:

1. A Client places a best efforts VWAP order to buy 10000 shares of X. Accordingly, a Leg A trade to buy 10000 shares of X is created.

2. Crossposter creates a shadow order to cross buy 10000 shares at VWAP in the crossing pool. This is the Leg B trade.

3. The entire Leg B trade crosses. That is, all of the buy 10000 shares at VWAP is crossed in the crossing pool with a contra-order. Crossposter thus attempts to cancel the Leg A trade. Before the cancel can be processed, however, 100 shares of the Leg A trade execute. The Leg A cancel is acknowledged at this point, and the rest of the Leg A (9900) is canceled. In this case, Crossposter creates a Leg C to buy 9900 shares X (that is, 10000 (the original order size)−100(the executed best efforts portion)=9900). Crossposter also internally creates (hidden from Client) a Leg D trade to sell 9900 shares of X. At this point, netting off (adding together) the Leg B (cross 10000) and Leg D (sell 9900), there is a position of 100 shares remaining. Thus, there is a non-zero position, which signals to the system that there is an overfill of 100 shares. The system can request/perform an automatic unwind or can generate an alert for a trader notifying of the position and the need to manually unwind the position. In the case of the automatic unwind, the system would place an order to sell 100 shares of A in a best efforts VWAP algorithm. In the case of a manual unwind, the trader might place and execute an order to buy 100 shares in a manual best efforts VWAP manner, or the trader might have a view on the stock and choose to buy 100 shares through some other means (e.g., purchasing right away at market levels).

4. Since the entire original order crossed, there is no need to perform further trading to satisfy the customer's order.

In an embodiment that allows for the possibility of overfill, the system can be designed to examine certain criteria, such as broker and/or order type (e.g., traditional vs. algorithmic), and use that to restrict crossing at certain times of day when the chance of an overfill is high or the impact of an overfill would be high. Such times could include, for example, at or near the open of the trading session and at or near the close of the trading session.

In an embodiment, the best efforts mechanism can avoid trading on the close of a trading session in order to reduce the risk that an order does not completely execute. For instance, the system can permit clients to specify algorithmic orders that are targeted to complete X minutes before the close of trading as equivalent to orders with an end time (for computing VWAP) as close of day. Alternatively, the system can automatically factor this modification in even if an earlier end time is not specified by a client.

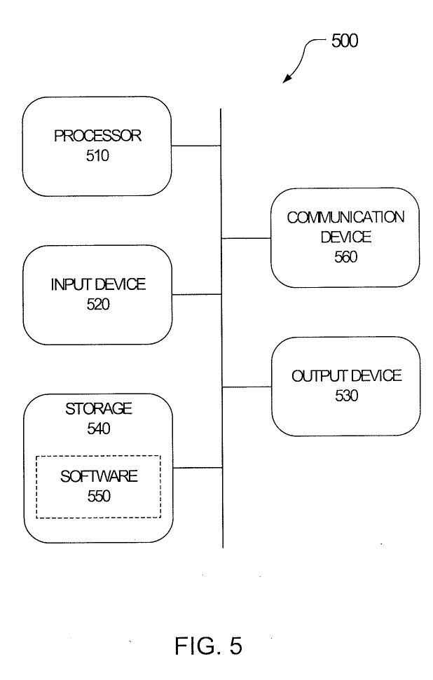

FIG. 5 shows a block diagram of an example of a computing device that can be employed in this system. In particular, the various components of the system depicted in FIG. 1 can be implemented through various computing devices. The form of computing device 500 may be widely varied. For example, computing device 500 can be a personal computer, workstation, server, handheld computing device, or any other suitable type of microprocessor-based device. Computing device 500 can include, for example, one or more components including processor 510, input device 520, output device 530, storage 540, and communication device 560. These components may be widely varied, and can be connected to each other in any suitable manner, such as via a physical bus, network line or wirelessly for example.

For example, input device 520 may include a keyboard, mouse, touch screen or monitor, voice-recognition device, or any other suitable device that provides input. Output device 530 may include, for example, a monitor or other display, printer, disk drive, speakers, or any other suitable device that provides output.

Storage 540 may include volatile and/or nonvolatile data storage, such as one or more electrical, magnetic or optical memories such as a RAM, cache, hard drive, CD-ROM drive, tape drive or removable storage disk for example. Communication device 560 may include, for example, a network interface card, modem or any other suitable device capable of transmitting and receiving signals over a network.

A network may connect computing device 500 with other computing devices. For instance, in FIG. 1, EMS 100 may be connected to crossing pool 110, broker 120, and/or exchange 130 via a network. The network may include any suitable interconnected communication system, such as a local area network (LAN) or wide area network (WAN) for example. The network may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 550 can be stored in storage 540 and executed by processor 510, and may include, for example, programming that embodies the functionality described in the various embodiments of the present disclosure. The programming may take any suitable form.

Software 550 can also be stored and/or transported within any computer-readable storage medium for use by or in connection with an instruction execution system, apparatus, or device, such as computing device 500 for example, that can fetch instructions associated with the software from the instruction execution system, apparatus, or device and execute the instructions. In the context of this document, a computer-readable storage medium can be any medium, such as storage 540 for example, that can contain or store programming for use by or in connection with an instruction execution system, apparatus, or device.

Software 550 can also be propagated within any transport medium for use by or in connection with an instruction execution system, apparatus, or device, such as computing device 500 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A computer-implemented method of trading financial assets, comprising:
receiving a first order specifying a first quantity of financial assets to be traded according to a volume-weighted average price for a trading session,
executing the first order during the trading session through algorithmic or traditional trading of the first quantity of financial assets on an exchange,
creating a second order specifying the first quantity of financial assets to be traded according to a volume-weighted average price measured from a moment of cross to an end of the trading session,
exposing the second order to a non-exchange crossing pool concurrently with the execution of the first order, the crossing pool comprising multiple orders, and
continuously determining whether any of the plurality of orders in the crossing pool can be crossed with the second order.

2. The method of claim 1 comprising:
identifying a contra-order from the plurality of orders in the crossing pool that can be crossed with the second order, the contra-order specifying a second quantity of financial assets to be traded according to a volume-weighted average price measured from a moment of cross to the end of the trading session, and
crossing the second order with the contra-order.

3. The method of claim 2 comprising removing the second order from the crossing pool and canceling the first order when the first quantity is equal to or less than the second quantity.

4. The method of claim 2 comprising amending the first and second orders to change the first quantity to be equal to a difference between the first quantity and the second quantity when the first quantity is greater than the second quantity.

5. The method of claim 1, wherein the algorithmic or traditional trading of the first quantity of financial assets on the exchange comprises trading portions of the first quantity of financial assets throughout the trading session in accordance with a volume profile of the financial asset.

6. The method of claim 5 comprising amending, when a portion of the first quantity of financial assets is traded, the first and second orders to change the first quantity to be equal to a difference between the first quantity and the portion.

7. The method of claim 1, wherein new orders can be received and immediately exposed to the crossing pool at any time during the trading session.

8. The method of claim 1 comprising verifying that a user profile associated with the first order permits cross pool trading as a prerequisite to performing the steps of creating the second order, exposing the second order to the crossing pool, and determining whether any of the plurality of orders in the crossing pool can be crossed with the second order.

9. A system for trading financial assets, comprising:
an order manager configured to receive a first order specifying a first quantity of financial assets to be traded according to a volume-weighted average price for a trading session,
an algorithmic engine configured to execute the first order during the trading session through algorithmic trading of the first quantity of financial assets on an electronic trading exchange, and
a cross poster configured to instruct the order manager to (i) create a second order specifying the first quantity of financial assets to be traded according to a volume-weighted average price measured from a moment of cross to an end of the trading session and (ii) expose the second order to a non-exchange crossing pool concurrently with the execution of the first order, the crossing pool being configured to continuously determine whether any of multiple orders in the crossing pool can be crossed with the second order.

10. The system of claim 9, wherein the crossing pool is configured to:
identify a contra-order from the plurality of orders in the crossing pool that can be crossed with the second order, the contra-order specifying a second quantity of financial assets to be traded according to a volume-weighted average price measured from a moment of cross to the end of the trading session, and
cross the second order with the contra-order.

11. The system of claim 10, wherein the order manager is configured to, if the first quantity is equal to or less than the second quantity, remove the second order from the crossing pool and cancel the first order.

12. The system of claim 10, wherein the order manager is configured to, if the first quantity is greater than the second quantity, cause the first and second orders to be amended to change the first quantity to be equal to a difference between the first quantity and the second quantity.

13. The system of claim 9, wherein the algorithmic trading of the first quantity of financial assets on the electronic trading exchange executed by the algorithmic engine comprises trading portions of the first quantity of financial assets throughout the trading session in accordance with a volume profile of the financial asset.

14. The system of claim 13, wherein the order manager is configured to, when a portion of the first quantity of financial assets is traded by the algorithmic engine, cause the first and second orders to be amended to change the first quantity to be equal to a difference between the first quantity and the portion.

15. The system of claim 9, wherein the order manager is configured to permit exposure of a newly received order to the crossing pool at any time during a remainder of the trading session.

16. The system of claim 9, wherein the cross poster is configured to verify that a user profile associated with the first order permits cross pool trading as a prerequisite to instructing the order manager to create the second order and expose the second order to the crossing pool.

17. A computer-readable medium storing a computer program to be executed on a computer system, the computer program causing the computer system to perform a method comprising:
receiving a first order specifying a first quantity of financial assets to be traded according to a volume-weighted average price for a trading session,
executing the first order during the trading session through algorithmic trading of the first quantity of financial assets on an electronic trading exchange,
creating a second order specifying the first quantity of financial assets to be traded according to a volume-weighted average price measured from a moment of cross to an end of the trading session,
exposing the second order to a non-exchange crossing pool concurrently with the execution of the first order, the crossing pool comprising multiple orders, and
continuously determining whether any of the plurality of orders in the crossing pool can be crossed with the second order.

18. A computer-implemented method of trading financial assets, comprising:
receiving a first order specifying a first quantity of financial assets to be traded according to a volume-weighted average price for a trading session,
causing the first order to be executed during the trading session through algorithmic trading of the first quantity of financial assets on an electronic trading exchange,
creating a second order specifying the first quantity of financial assets to be traded according to a volume-weighted average price measured from a moment of cross to an end of the trading session, and
causing the second order to be exposed to a non-exchange crossing pool concurrently with the execution of the first order, the crossing pool comprising multiple orders.
